(19) United States
(12) Patent Application Publication
(10) Pub. No.: US 2002/0017392 A1
(43) Pub. Date: Feb. 14, 2002

(54) Cable whose insulation varies in thickness

(76) Inventors: Lars Efraimsson, Haraldsbovagen (SE); Ulf Johnsen, Ostera (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/874,124

(22) Filed: Jun. 6, 2001

(30) Foreign Application Priority Data
Jun. 7, 2000 (SE) 0002284-4

(51) Int. Cl. H01B 7/00

(52) U.S. Cl. 174/110 R

(57) ABSTRACT

The present invention relates to an insulated electric cable (8) that has one or more conductors (4). With the intention of reducing the winding space, improving cooling, reducing stray flux and therewith improving the efficiency of apparatus and devices that include cable windings, the insulation of the cable in the cable winding has been given a varying thickness. The concept of providing the electric cable with insulation that varies in thickness can be utilised with both AC-cables and DC-cables. Moreover, the nature of the voltage concerned need not be decisive in the manufacture of the cable. The thickness distribution of the insulation may be linear (11) or non-linear (12), depending on the adaptation to the desired field strength distribution. The invention enables smaller, fewer and more effective apparatus and devices to be constructed.

### FIELD OF INVENTION

The present invention relates to an insulating electric cable where the thickness of the insulation varies along the length of the cable.

### DESCRIPTION OF THE BACKGROUND ART

In the manufacture of insulated electric cables for higher voltages (>3 kV) there is normally used a method in which cable insulation is surrounded by a conductive layer both against the conductor on the voltage side and against the screen on the earth side. This is necessary in order to obtain sufficiently smooth surfaces against the insulation, so as to avoid amplifications of the electric field strength due to the point effect ?. This type of cable is normally produced by a so-called triple extrusion process in which all three layers are extruded on the conductor in one single operation. Cross-linked polyethylene (PEX) is the most common insulation material used at present in this regard.

In order to save material and also in order to keep the electric field strength in the insulating material as even as possible, efforts are made to accurately control the thickness of the insulation layer and to maintain the thickness as constant as possible along the full length of the cable. This preferably applies to power transmission cables in which the voltage is essentially constant along the full length of the cable.

### SUMMARY OF THE INVENTION

When using cables for purposes in which the voltage is not constant along the length of the cable, for instance in transformer windings, generator windings, the windings of electric motors and in other areas where it is appropriate for the insulating capacity of the cable to vary along its length. it may be beneficial to vary the thickness of the insulation thickness along the length of the cable. This will enable the field strength in the insulation to be kept constant as far as possible, or enable the field strength to kept at a value that is considered suitable with respect tot each point along the cable. The present invention relates to a cable construction that has these properties.

Conceivable areas of use for electric cables constructed in accordance with the present invention are transformer windings, generator windings, electric motor windings or similar windings with which the voltage can be changed along the coiled or wound electric cable. It is then highly beneficial to be able to provide a cable winding with a varying insulation thickness, as the winding space for relevant apparatus can be reduced and cooling improved, while stray flux can be reduced and the efficiency of the apparatus enhanced. For example, a cable winding can have a low voltage at one end of the winding and, e.g., a high voltage in excess 100 000 volts at the other end of the winding. Normally, there are used in the windings of such apparatus varnished or lacquered wires which are only able to manage some thousand volts, therefore requiring the provision of transformers for converting the voltage to a correct level either upstream or downstream of the apparatus.

When extruding a cable in accordance with the invention, the process parameters in an extrusion line are varied so as to enable the thickness of the insulation to be altered continuously along the length of the cable and therewith to obtain, as far as possible, a constant field strength along or around the wound cable, in relation to the application in which the cable is intended to be used. This results in a saving of material, since the use of material can be optimised along the length of the cable.

Other electrical advantages are achieved with the proposed invention, where the alternative to an inventive cable is to use several cable-sections of different lengths with a constant insulation thickness in each section, therewith needing to splice or otherwise join the cable sections together to obtain a cable of the desired length. A cable splice constitutes a weakening of the cable. In transient electric processes, impedance changes in cable splices and joins result in reflections and voltage increases that can lead to a disruptive discharge or breakdown. This may make it necessary to re-dimension the entire cable, therewith making the whole of the cable construction larger and more expensive.

The proposed method according to the invention can be applied with respect to AC-cables and DC-cables and the nature of the voltage need not necessarily be decisive when manufacturing the cable. The thickness of the insulation can be varied within wide limits, and a thickness ratio of 1:3 between the smallest and the largest layer thickness can be achieved with standard production equipment. Even higher ratios can be achieved with specially adapted manufacturing equipment. The total length of the cable can be varied within wide limits, from a few meters up to several kilometers. The change in insulation thickness need not be linear along the cable, but can be adapted to the desired field strength distribution. In summary, the invention enables smaller, fewer and more effective apparatus and devices to be constructed.

The invention will now be described in more detail with reference to preferred embodiments and also with reference to the accompanying drawings.

### BRIEF DESCRIPTION OF THE DRAWINGS

FIG. 1 is a radial cross-sectional view of one end of an insulated cable according to the invention.

FIG. 2 is a radial cross-sectional view at the other end of an insulated cable according to the present invention.

FIG. 3 is an axial sectioned view of an inventive insulated cable whose insulation thickness varies linearly along the length of the cable.

FIG. 4 is an axial sectional view of an insulated cable according to the invention where the insulation thickness varies non-linearly along the length of the cable.

### DESCRIPTION OF PREFERRED EMBODIMENTS

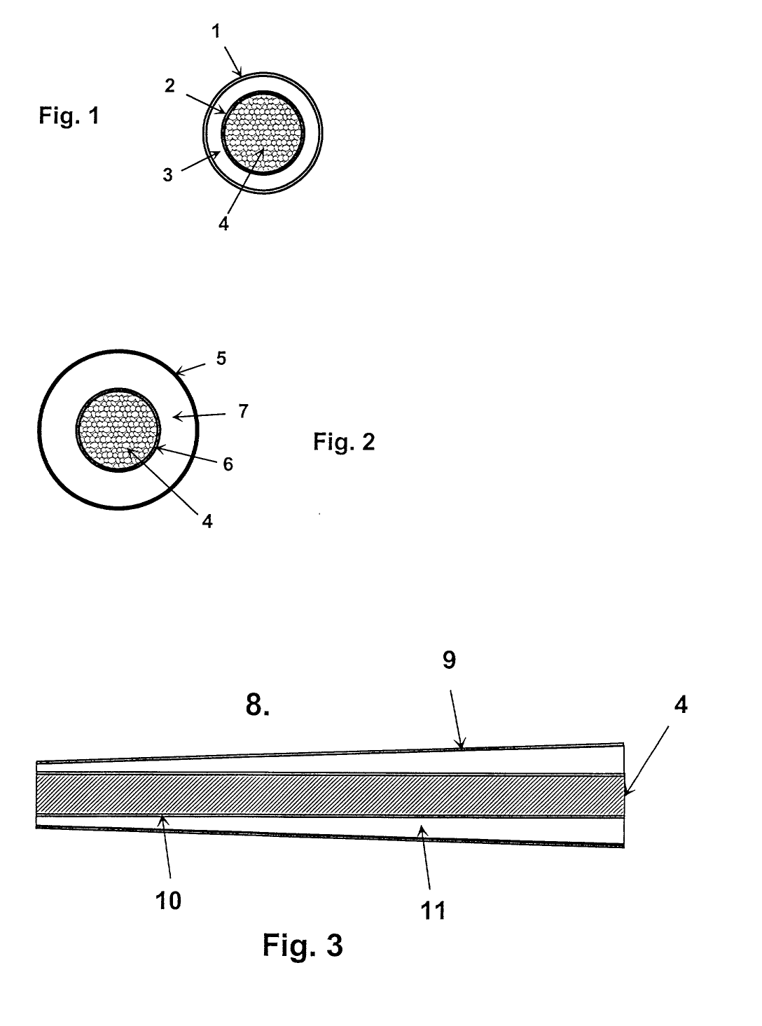

FIG. 1 is a radial sectioned view of one end of an inventive electric cable. The cable has an outer surrounding conductive layer I and an inner conductive layer 2. An insulation 3 is disposed between the inner and the outer conductive layers, and a conductor 4 is disposed in the centre of the cable.

FIG. 2 is a radially sectioned view of another end of the inventive electric cable. The cable has a surrounding outer conductive layer 5 and an inner conductive layer 6. An insulation 7 is disposed between the inner and the outer conductive layers, and it will clearly be seen that the thickness of the insulation is larger than the thickness of the insulation in the FIG. 1 illustration. A conductor 4 is disposed in the centre of the cable.

FIG. 3 is an axial sectioned view of a complete inventive electric cable 8, with an axial cross-section corresponding to the cross-sections shown in FIGS. 1 and 2, and has an outer conductive layer 9, an inner conductive layer 10, an insulation 11 and the conductor 4. It will clearly be seen from FIG. 3 that the thickness of the insulation increases linearly from one end of the cable to the other.

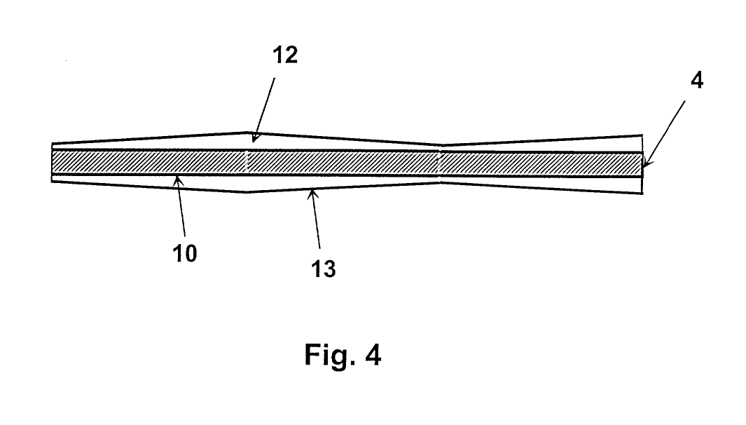

FIG. 4 is an axial sectioned view of another inventive electric cable. which includes an outer conductive layer 13, an inner conductive layer 10, an insulation 12 disposed between the conductive layers, and the conductor 4. It will clearly be seen from FIG. 4 that the thickness distribution of the insulation 12 between one end of the cable and its other end is non-linear.

It will be understood that the invention is not restricted to the aforedescribed and illustration exemplifying embodiments thereof and that modifications can be made within the scope of the accompanying claims.

1. An insulated electrical conductor such as an insulated electric cable that has one or more conductors and which may include an inner and an outer conductive layer with insulation sandwiched between said layers, characterised in that the thickness of the insulation (3,7,11;12) varies in the longitudinal direction of the cable.

2. An insulated electrical conductor according to claim 1, characterised in that the thickness of the insulation (3,7.11) varies linearly in the longitudinal direction of the cable.

3. An insulated electrical conductor according to claim 1, characterised in that the thickness of the insulation (12) varies non-linearly in the longitudinal direction of the cable.

4. An insulated electrical conductor according to claim 1, characterised in that the thickness of the insulation (3,7,11) varies in the longitudinal direction of the cable varies within a ratio grater than 1:1.5.

5. An insulated electrical conductor according to claim 1, characterised in that the thickness of the insulation (3,7,11) varies in the longitudinal direction of the cable varies within a ratio greater than 1:1.2.
